(19) United States
(12) Patent Application Publication
(10) Pub. No.: US 2026/0128458 A1
(43) Pub. Date: May 7, 2026

(54) BATTERY PACK

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/331,073

(22) Filed: Sep. 17, 2025

(30) Foreign Application Priority Data
Nov. 1, 2024 (JP) 2024-193011

(51) Int. Cl. H01M 50/367; H01M 10/658; H01M 50/209; H01M 50/244

(52) U.S. Cl. CPC H01M 50/367; H01M 10/658; H01M 50/209; H01M 50/244; H01M 2200/20; H01M 2220/20

(57) ABSTRACT

A battery pack includes a battery cell that includes a safety valve that opens when internal pressure increases and externally releases gas, an exhaust passage through which gas released from the safety valve flows, a heat insulating member provided to cover the safety valve, and a holding member that holds the heat insulating member, in which an accommodating portion is provided in a wall portion of the exhaust passage at a position facing the heat insulating member, and the heat insulating member provides thermal insulation between the exhaust passage and the battery cell when the safety valve is not opened, and is separated from the holding member and accommodated in the accommodating portion by the gas released from the safety valve when the safety valve is opened, so as to provide thermal insulation between the gas released from the safety valve and the wall portion of the exhaust passage.

### CROSS-REFERENCE TO RELATED APPLICATION

This application claims priority to Japanese Patent Application No. 2024-193011 filed on November 1, 2024. The disclosure of the above-identified application, including the specification, drawings, and claims, is incorporated by reference herein in its entirety.

### BACKGROUND

### 1.Technical Field

The present disclosure relates to a battery pack.

### 2. Description of Related Art

WO 2020/110448 discloses that in a battery pack having an exhaust duct upward from a battery module, an impact absorbing layer is provided on a face of the exhaust duct facing a safety valve of a battery cell, to protect the exhaust duct from high-temperature gas that is released from the safety valve.

### SUMMARY

In a configuration that is described in WO 2020/110448, there is no heat insulating member provided to thermally insulate the battery cells from the gas in the exhaust duct, and accordingly when gas is released from an abnormal battery cell into the exhaust duct, normal cells will be subjected to heat from the gas in the exhaust duct. In this case, there is a concern that normal cells may become excessively hot and start to generate abnormal heat, which may lead to a chain reaction of abnormal heat generation in the battery cells. One conceivable solution is to provide a heat insulating member to thermally insulate the battery cells from the gas inside the exhaust duct.

However, adding a heat insulating member to thermally insulate the battery cells from the gas in the exhaust duct to a structure in which a heat insulating member for protecting the exhaust duct is provided, as in the configuration that is described in WO 2020/110448, will raise costs.

The present disclosure has been made in consideration of the above-described circumstances, and an object thereof is to provide a battery pack that can protect wall portions of an exhaust passage and the battery cells from high-temperature gas that is released from the battery cells, while suppressing increases in costs.

A battery pack according to the present disclosure includes a battery cell that includes a safety valve that opens when internal pressure increases, and externally releases gas, a battery module in which a plurality of the battery cells is disposed arrayed, a case that accommodates the battery module, an exhaust passage through which gas that is released from the safety valve flows, a heat insulating member that is provided to cover the safety valve, and that faces the exhaust passage, and a holding member that is provided between the battery cells and the case, and that holds the heat insulating member, in which an accommodating portion is provided in a wall portion of the exhaust passage at a position facing the heat insulating member, and the heat insulating member provides thermal insulation between the exhaust passage and the battery cell when the safety valve is not opened, and is separated from the holding member and accommodated in the accommodating portion by the gas that is released from the safety valve when the safety valve is opened, so as to provide thermal insulation between the gas that is released from the safety valve and the wall portion of the exhaust passage.

According to the present disclosure, the wall portion of the exhaust passage and the battery cells can be protected from high-temperature gas that is released from the battery cells, while suppressing increases in costs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a battery pack according to an embodiment;

FIG. 2 is a diagram illustrating a heat insulating member for thermally insulating a battery cell from an exhaust passage;

FIG. 3 is a diagram illustrating a state in which the heat insulating member that is separated from a holding member is accommodated in an accommodating portion to thermally insulate wall portions of the exhaust passage from gas when a safety valve is opened;

FIG. 4 is a diagram illustrating a structure of the accommodating portion;

FIG. 5 is a diagram schematically illustrating the battery pack according to a modification; and

FIG. 6 is a diagram illustrating a case in which the safety valve in the battery pack according to the modification is open.

### DETAILED DESCRIPTION OF EMBODIMENTS

A battery pack according to an embodiment of the present disclosure will be described in detail below. Note that the present disclosure is not limited to the embodiment that is described below.

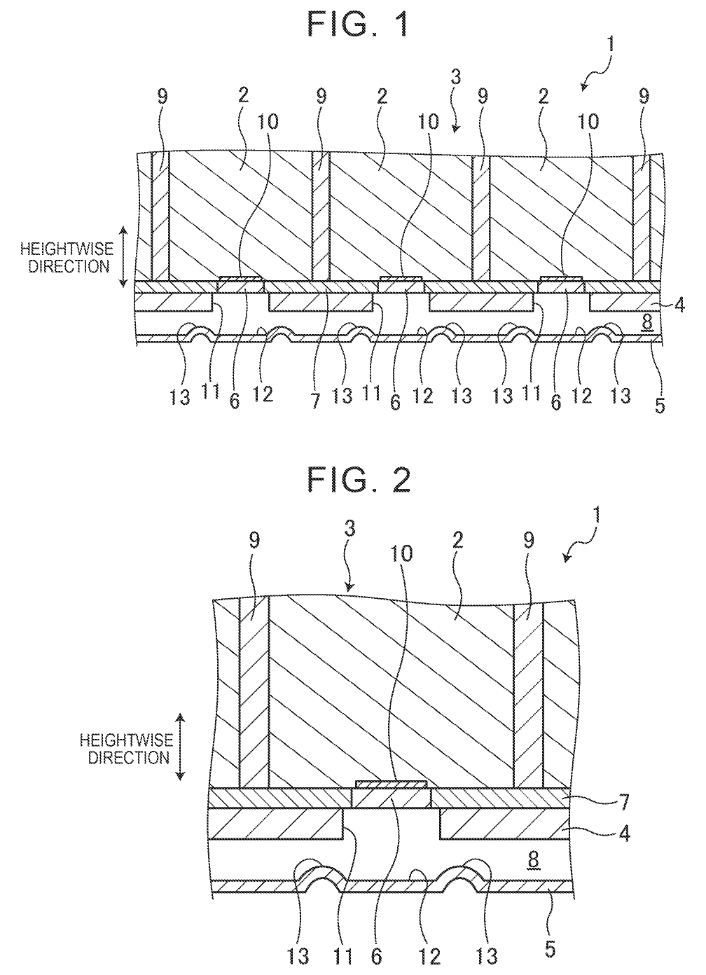

FIG. 1 is a diagram schematically illustrating the battery pack according to the embodiment. The battery pack 1 is a power storage device in which a battery module 3, in which a plurality of battery cells 2 is stacked, is accommodated inside a case 4. The battery pack 1 is installed in an electrified vehicle, such as a battery electric vehicle, a hybrid electric vehicle, or the like. An electrified vehicle travels by supplying electric power that is stored in the battery pack 1 to a traction motor.

The battery pack 1 includes the battery module 3, the case 4, a shear panel 5, heat insulating members 6, a holding member 7, and an exhaust passage 8.

The battery module 3 is an assembled battery in which a plurality of battery cells 2 is disposed in an arrayed manner. The battery module 3 has a stack in which the battery cells 2 and coolers 9 are alternately stacked. The coolers 9 have a channel therein, through which a coolant flows, and the battery cells 2 are cooled by the coolant. The coolers 9 are formed in the shape of a hollow flat plate.

Each of the battery cells 2 is a prismatic battery that is formed in a cuboid shape. The battery cell 2 is made up of a lithium ion battery. The battery cell 2 has a rectangular cell case and a safety valve 10. The safety valve 10 is provided on a lower face of the cell case of the battery cell 2.

The safety valve 10 opens when internal pressure of the battery cell 2 increases, and externally releases gas within the battery cell 2. When the internal pressure of the battery cell 2 rises to or exceeds a predetermined value, the safety valve 10 opens. For example, the safety valve 10 includes a thin-walled portion that is thinner than other portions, and a groove that is provided in the thin-walled portion. When the internal pressure of the battery cell 2 rises, the thin-walled portion tears starting from the groove, causing the safety valve 10 to open. Gas inside the battery cell 2 is discharged through the safety valve 10 into the exhaust passage 8.

The exhaust passage 8 is a passage through which gas released from the safety valve 10 flows. The exhaust passage 8 is provided downward from the battery module 3 and is defined by the case 4, the shear panel 5, and the heat insulating members 6. The safety valve 10 of each of the battery cells 2 is connected to the exhaust passage 8. The exhaust passage 8 allows gas to be released from any of the battery cells 2.

The case 4 accommodates the battery module 3. The case 4 includes an upper cover and a lower case. The case 4 is a battery pack case that accommodates the battery cells 2. The battery cells 2 are disposed on a bottom portion of the case 4. The bottom portion of the case 4 is provided with exhaust holes 11 that each pass therethrough in a heightwise direction, at a position corresponding to the safety valve 10 of each of the battery cells 2. The exhaust holes 11 are through holes that discharge gas that is released from the safety valves 10 to the exhaust passage 8.

The shear panel 5 is a plate-like protective member that is disposed below the case 4 and that protects the battery pack 1 against external forces applied from below. The shear panel 5 is formed so as to face the entire lower face of the case 4, and is attached to a support member that supports the case 4, or to the case 4 itself. The shear panel 5 is a metal plate that makes up a bottommost face. The shear panel 5 is made of aluminum.

The heat insulating members 6 are flat plate-shaped heat insulating member that are disposed at positions facing the safety valves 10, and are provided so as to cover the safety valves 10. The heat insulating members 6 are provided downward from the safety valves 10, which is to say downward from the battery cells 2. The heat insulating members 6 have electrical insulating properties. The heat insulating members 6 are made of mica, alumina, glass, calcium silicate, or the like. The heat insulating members 6 are held by the holding member 7. The heat insulating members 6 and the holding member 7 are formed integrally.

The holding member 7 is a flat plate-shaped member that is provided between the battery cells 2 and the case 4. The holding member 7 has electrical insulating properties. The holding member 7 is made of resin. For example, the holding member 7 is a resin film or a resin sheet. The battery cells 2 are installed on the bottom portion of the case 4 via the holding member 7.

In the battery pack 1 that is configured in this manner, the heat insulating members 6 are configured to protect wall portions of the exhaust passage 8 from gas that is released from the safety valve 10, and also to protect the battery cells 2 from the high-temperature gas within the exhaust passage 8. The heat insulating members 6 are heat insulating members for thermally insulating between gas that is released from the safety valves 10 and the wall portions of the exhaust passage 8, and also for thermally insulating between the gas in the exhaust passage 8 and the battery cells 2.

The heat insulating members 6 are configured to be separable from the holding member 7. The holding member 7 has through holes provided therein that correspond to the shape of the heat insulating members 6. The heat insulating members 6 are fitted into the through holes that are provided in the holding member 7. For example, a state in which the heat insulating members 6 are fitted into the through holes of the holding member 7 is a state in which the heat insulating members 6 are held by the holding member 7. The strength with which the holding member 7 holds the heat insulating members 6 is such that the heat insulating members 6 can be separated from the holding member 7 when the battery cells 2 generate abnormal heat, gas or particles are released from the safety valves 10, and the gas strikes against the heat insulating members 6. Also, the heat insulating members 6 have strength sufficient to not be damaged by force of gases and particles that are released from the safety valves 10. The heat insulating members 6 have strength that allows the same shape as that before separation to be maintained even after separation from the holding member 7.

The heat insulating members 6 face the exhaust passage 8 via the exhaust holes 11 in the case 4. Accommodating portions 12 are provided in the exhaust passage 8 at positions facing to the heat insulating members 6. The accommodating portions 12 are structures for accommodating the heat insulating members 6 that are separated from the holding member 7. The exhaust passage 8 is provided with spaces for accommodating the heat insulating members 6. The accommodating portions 12 are provided on the shear panel 5 and have protrusions 13 that protrude towards the battery cell 2 side. The protrusions 13 are shaped so as to correspond to the shape of the heat insulating members 6. For example, the protrusions 13 are shapes that entirely surround the heat insulating members 6 that are separated. The protrusions 13 are provided when the shear panel 5 is press-formed.

When a certain battery cell 2 is normal and the safety valve 10 does not open, the heat insulating member 6 provides thermal insulation between the battery cell 2 and the exhaust passage 8. Even when another battery cell 2 generates abnormal heat, and high-temperature gas or high-temperature particles pass over the lower face of the case 4, the heat insulating member 6 is held at the normal battery cell 2, and this insulating material 6 functions to thermally insulate the normal battery cell 2 such that the temperature thereof does not rise due to the gas in the exhaust passage 8.

When the safety valve 10 opens in a battery cell 2 that has abnormally generated heat, the heat insulating member 6 separates from the holding member 7 due to the gas released from the safety valve 10 and travels toward the accommodating portion 12, and thermally insulates the shear panel 5 from the gas in a state of being accommodated in the accommodating portion 12. The heat insulating member 6 that is separated is held in the accommodating portion 12 by the force of gravity. When the battery cell 2 generates abnormal heat, the heat insulating member 6 drops onto the shear panel 5 to protect the shear panel 5 from high-temperature gas.

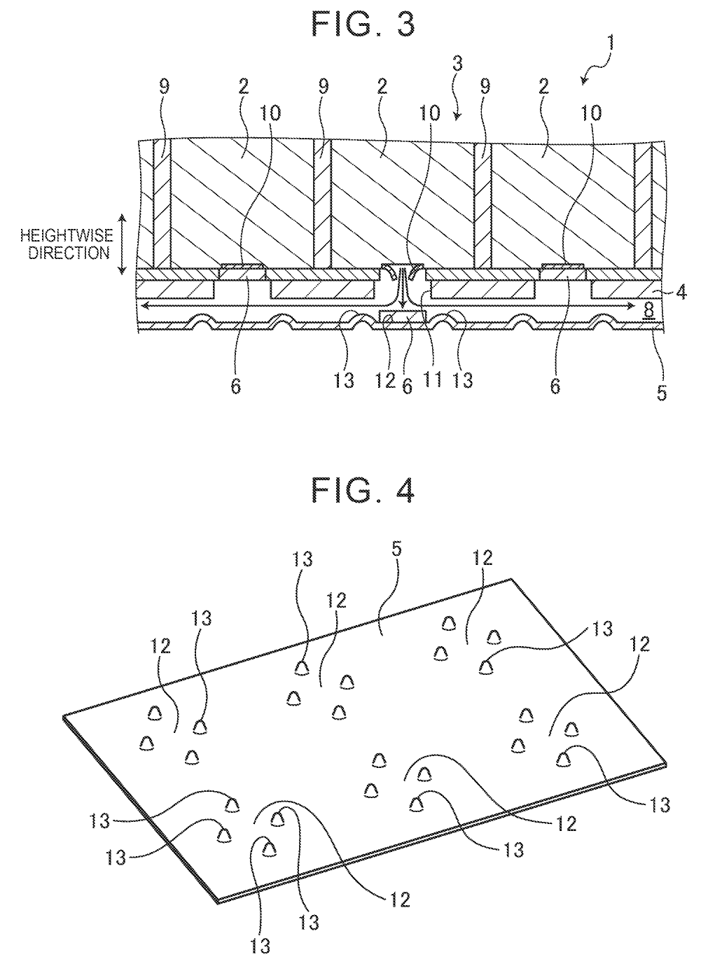

As illustrated in FIG. 3, the heat insulating member 6 that is accommodated in the accommodating portion 12 is interposed between the gas being released from the safety valve 10, which is opened, toward the accommodating portion 12 and the wall portion of the exhaust passage 8, and receives the gas. This heat insulating member 6, which is in a state of receiving the gas, provides thermal insulation between the gas and the wall portion of the exhaust passage 8. When the safety valve 10 opens at any one battery cell 2 of the battery cells 2, the other battery cells 2 are thermally insulated from the gas flowing through the exhaust passage 8 by the heat insulating members 6 that are held by the holding member 7.

As described above, according to the embodiment, the normal battery cells 2 are thermally insulated from the high-temperature gas in the exhaust passage 8 by the heat insulating members 6 that are held in the holding member 7, and when the battery cell 2 exhibits abnormally heating, the heat insulating member 6 that has moved to the accommodating portion 12 can protect the wall portions of the exhaust passage 8. The wall portions of the exhaust passage 8 and the battery cells 2 can be protected by the same heat insulating member 6. Thus, increase in costs can be suppressed.

Note that the heat insulating members 6 may be held by a material that melts under heat when the battery cells 2 generate abnormal heat. For example, the heat insulating members 6 and the holding member 7 are fused together, and the holding member 7 is melted by the high-temperature gas released from the safety valve 10. The gas from the safety valve 10 melts the holding member 7, whereby the heat insulating member 6 separates from the holding member 7.

Also, spacers made of resin may be provided instead of the coolers 9. The spacer has electrical insulating properties. In the battery module 3, spacers are disposed between battery cells 2 that are adjacent in a stacking direction.

Furthermore, the shape of the accommodating portion 12 is not limited in particular, as long as it can accommodate the heat insulating member 6. The accommodating portion 12 may be formed of a plurality of the protrusions 13, as illustrated in FIG. 4.

Also, the exhaust passage 8 is not limited to a structure defined by the case 4, the shear panel 5, and the heat insulating members 6. Further, the member facing the heat insulating members 6 is not limited to the shear panel 5. In addition, the exhaust passage 8 is not limited to a structure that is provided downward from the battery module 3, and may be a structure that is provided upward from the battery module 3. The battery pack 1 according to a modification can have a structure in which the exhaust passage 8 is provided upward from the battery module 3.

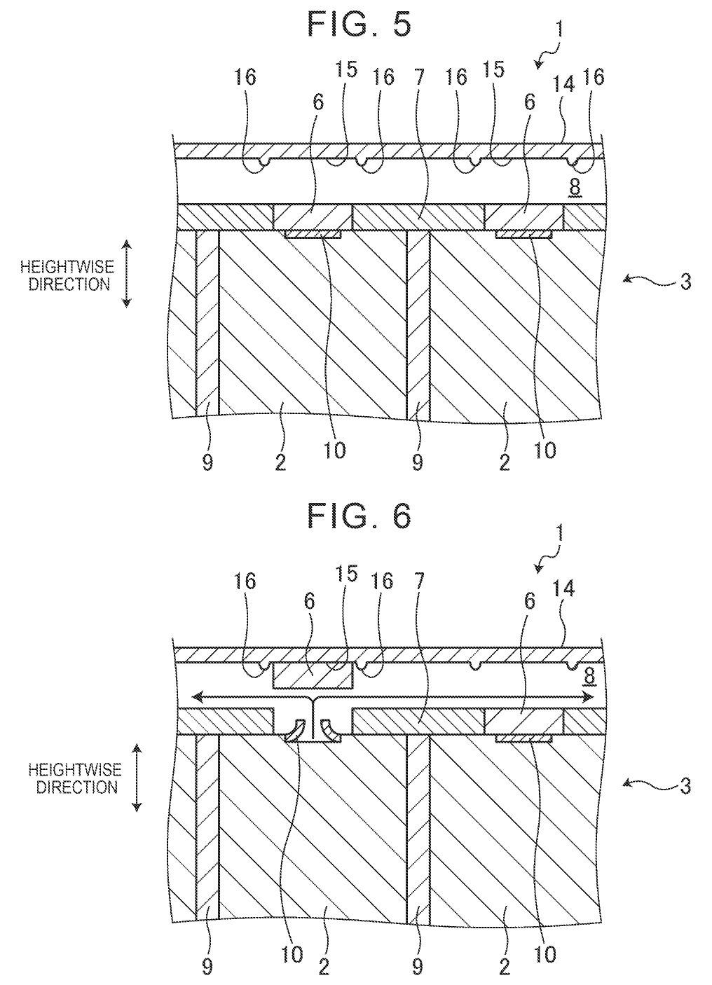

As illustrated in FIG. 5, in the battery pack 1 of the modification, the safety valve 10 is provided on an upper face of the cell case of the battery cell 2, and the exhaust passage 8 is provided above the battery module 3. The heat insulating member 6 is provided above the safety valve 10, i.e., above the battery cell 2. The holding member 7 is disposed above the battery cell 2. The exhaust passage 8 is defined by an exhaust duct 14, the heat insulating members 6, and the holding member 7. The exhaust duct 14 is a member that forms the wall portion of the exhaust passage 8. The exhaust duct 14 is accommodated inside of the case 4.

Accommodating portions 15 are provided in a wall portion of the exhaust duct 14 at positions facing the heat insulating members 6. The accommodating portions 15 are structures for accommodating the heat insulating members 6 that are separated upward from the holding member 7. As illustrated in FIG. 6, the heat insulating member 6 that is separated is held in the accommodating portion 15 against gravity by the force of gas and particles released from the safety valves 10 of the battery cells 2.

The accommodating portion 15 has protrusions 16 that protrude from the exhaust duct 14 towards the battery cell 2 side. The heat insulating member 6 that is accommodated in the accommodating portion 15 is interposed between the gas being released from the safety valve 10, which is opened, toward the accommodating portion 15 and the wall portion of the exhaust duct 14, and receives the gas. This heat insulating member 6 provides thermal insulation between the gas and the wall portion of the exhaust duct 14 in a state of receiving the gas. When the release of gas from the safety valve 10 is completed, the heat insulating member 6 held in the accommodating portion 15 may fall toward the safety valve 10 side due to the force of gravity. Also, the exhaust duct 14 may be a separate member from the case 4 or may be an upper cover of the case 4.

What is claimed is:

1. A battery pack comprising:
a battery cell that includes a safety valve that opens when internal pressure increases, and externally releases gas;
a battery module in which a plurality of the battery cells is disposed arrayed;
a case that accommodates the battery module;
an exhaust passage through which gas that is released from the safety valve flows;
a heat insulating member that is provided to cover the safety valve, and that faces the exhaust passage; and
a holding member that is provided between the battery cells and the case, and that holds the heat insulating member, wherein
an accommodating portion is provided in a wall portion of the exhaust passage at a position facing the heat insulating member, and
the heat insulating member provides thermal insulation between the exhaust passage and the battery cell when the safety valve is not opened, and is separated from the holding member and accommodated in the accommodating portion by the gas that is released from the safety valve when the safety valve is opened, so as to provide thermal insulation between the gas that is released from the safety valve and the wall portion of the exhaust passage.

2. The battery pack according to claim 1, wherein the heat insulating member accommodated in the accommodating portion is interposed between the wall portion of the exhaust passage and the gas while receiving the gas being released from the safety valve, that is opened, toward the accommodating portion.

3. The battery pack according to claim 2, wherein, when the safety valve is opened in any one of the battery cells, other battery cells are thermally insulated from the gas in the exhaust passage by the heat insulating members that are held by the holding member.

4. The battery pack according to claim 3, further comprising:
a shear panel that is disposed downward from the case, wherein
the exhaust passage is defined by the case and the shear panel,
an exhaust hole that opens into the exhaust passage is provided in a bottom portion of the case,
the safety valve is provided on a lower face of the battery cell,
the holding member is provided between the lower face of the battery cell and the bottom portion of the case,
the heat insulating member faces the exhaust passage through the exhaust hole, and
the accommodating portion is provided on the shear panel and includes a plurality of protrusions that protrude toward a battery cell side.
